(19) United States
(12) Patent Application Publication
(10) Pub. No.: US 2020/0407255 A1
(43) Pub. Date: Dec. 31, 2020

(54) METHOD FOR SEPARATING ORGANIC MATTER FROM NATURAL WATER BODY

(71) Applicant: Jilin Jianzhu University, Changchun (CN)

(72) Inventors: Yingzi Lin, Changchun (CN); Huan Lin, Changchun (CN); Zunjing LV, Changchun (CN); Zeming Zhao, Changchun (CN)

(73) Assignee: Jilin Jianzhu University, Changchun (CN)

(21) Appl. No.: 16/736,169

(22) Filed: Jan. 7, 2020

(30) Foreign Application Priority Data
Jun. 28, 2019 (CN) 201910575585.2

(51) Int. Cl. C02F 9/00

(52) U.S. Cl. CPC C02F 9/00; C02F 1/44

(57) ABSTRACT

The present invention provides a method for separating an organic matter from a natural water body, and belongs to the field of water purification. In the present invention, organic matters in the natural water body are divided into six categories, and three different kinds of resins are used, namely an XAD-7HP macroporous adsorption resin, a 15-WET strong-acid cation exchange resin and an A-23 weak-base anion exchange resin; the XAD-7HP macroporous adsorption resin sequentially adsorbs a hydrophobic neutral (HPON), a hydrophobic base (HPOB) and a hydrophobic acid (HPOA) in the natural water body, then the 15-WET strong-acid cation exchange resin absorbs a hydrophilic base (HPIB), and finally, the A-23 weak-base anion exchange resin adsorbs a hydrophilic acid (HPIA), retaining a hydrophilic neutral (HPIN) in the remaining water body.

### TECHNICAL FIELD

The present invention relates to the technical field of water purification, and in particular, to a method for separating an organic matter from a natural water body.

### BACKGROUND

There are nearly a thousand kinds of dissolved organic matters (DOMs) in surface water bodies. How to separate the organic matters is a problem that people have been exploring. It is generally believed that a DOM in a water body is an organic matter that can pass a filter membrane having a pore size of 0.45 μm.

There are a wide variety of organic matters in natural water bodies, and their composition is complicated. It is necessary to separate and enrich DOMs. Traditional separation methods have shortcomings. For example, a solution extraction method and an activated carbon adsorption method have a low recovery rate; a reverse osmosis method and an ultrafiltration method are advanced, but they have the problems of high cost and low recovery rate as they lack a systematic process flow.

### SUMMARY

An objective of the present invention is to provide a method for separating an organic matter from a natural water body. The method provided by the present invention has a high removal rate of the organic matter and a high recovery rate of the natural water body.

To achieve the above purpose, the present invention provides the following technical solution.

A method for separating an organic matter from a natural water body includes the following steps:

filtering the natural water body, then adjusting pH to 7, allowing the natural water body to flow through a first XAD-7HP resin column, and eluting the resin column with methanol, where the water sample flowing through the resin column is a first water sample;

adjusting the pH of the first water sample to 10, allowing the first water sample to flow through a second XAD-7HP resin column, and eluting the resin column with hydrochloric acid, where the water sample flowing through the resin column is a second water sample;

adjusting the pH of the second water sample to 2, allowing the second water sample to flow through a third XAD-7HP resin column, and eluting the resin column with a first sodium hydroxide solution, where the water sample flowing through the resin column is a third water sample;

adjusting the pH of the third water sample to 7, allowing the third water sample to flow through a 15-WET resin column, and eluting the resin column with a second sodium hydroxide solution, where the water sample flowing through the resin column is a fourth water sample; and allowing the fourth water sample to flow through an A-23 resin column, and eluting the resin column with a third sodium hydroxide solution, where the water sample flowing through the resin column is a fifth water sample.

Preferably, a filter membrane used for the filtering has a pore size of 0.45 μm.

Preferably, a buffer solution used for adjusting the pH to 7 after the natural water body is filtered is a phosphate buffer solution having a pH of 7.

Preferably, an adjusting reagent used for adjusting the pH to 10 is a 2 mol/L NaOH solution. Preferably, the second XAD-7HP resin column is eluted with 0.25 times column volume of 0.1 mol/L HCl and 1.5 times column volume of 0.01 mol/L HCl in sequence to obtain a hydrochloric acid eluate.

Preferably, an adjusting reagent used for adjusting the pH to 2 is a 1 mol/L HCl solution.

Preferably, the third XAD-7HP resin column is eluted with 0.25 times column volume of 0.1 mol/L NaOH solution and 1.25 times column volume of 0.01 mol/L NaOH solution in sequence to obtain a first NaOH eluate.

Preferably, the 15-WET resin column is eluted with 1.5 times column volume of 1 mol/L NaOH solution to obtain a second NaOH eluate.

Preferably, the A-23 resin column is eluted with 1.5 times column volume of 0.1 mol/L NaOH solution and 1 time column volume of 0.01 mol/L NaOH solution in sequence to obtain a third NaOH eluate.

Preferably, the natural water body includes surface source water and groundwater of drinking water, a water body after flowing through various treatment units of a water purification plant, and a water body including a dissolved organic matter and flowing into and out of a sewage plant.

The present invention separates organic matters in the natural water body based on six categories, specifically including: a hydrophobic acid (HPOA), a hydrophobic base (HPOB), a hydrophobic neutral (HPON), a hydrophilic acid (HPIA), a hydrophilic base (HPIB), and a hydrophilic neutral (HPIN), among which the hydrophobic acid mainly includes humus, a soil fulvic acid, C₅ to C₉ aliphatic carboxylic acids, 1-cyclic and 2-cyclic aromatic carboxylic acids, 1-cyclic and 2-cyclic phenols, and the like; the hydrophobic base mainly includes an aromatic amine, 1-cyclic and 2-cyclic aromatic hydrocarbons (except pyrimidine), a protein, and the like; the hydrophobic neutral mainly includes a hydrocarbon, an insecticide, a synthetic detergent, an aliphatic alcohol (>C5), amide, aldehyde, ketone and ester, an aliphatic carboxylic acid (>C9) and amine, an aromatic carboxylic acid (>3-cyclic) and amine, and the like; the hydrophilic acid mainly includes an alphatic acid, a hydroxy acid, an alphatic organic acid (<C5) and polyfunctional carboxylic acid, and the like; the hydrophilic base mainly includes pyridine, an amphoteric protein (an aliphatic amino acid, an alphatic amine of an amino sugar (<C9), polypeptide, protein), and the like; the hydrophilic neutral mainly includes an oligosaccharide, a polysaccharide, an aliphatic alcohol (<C5), polyfunctional alcohol, short-chain aliphatic amine, amide, aldehyde, ketone, ester, cyclic amide, carbohydrate, and the like; three different kinds of resins are used, namely an XAD-7HP macroporous adsorption resin, a 15-WET strong-acid cation exchange resin and an A-23 weak-base anion exchange resin; the XAD-7HP macroporous adsorption resin sequentially adsorbs the HPON, the HPOB and the HPOA in the natural water body, then the 15-WET strong-acid cation exchange resin absorbs the HPIB, and finally, the A-23 weak-base anion exchange resin adsorbs the HPIA, retaining the HPIN in the water. Experimental results show that the recovery rate of the separation method provided by the present invention reaches 100.73-110.74%.

The present invention is a method for separating and enriching a dissolved organic matter (DOM) from water based on an XAD-7HP resin separation method. The separation and enrichment are performed according to the polarity and acid-base property of the DOM in the natural water body. Organic matters are divided into six components, and the properties of the components are studied, which is greatly helpful for the study of DOM components having different properties, and achieves better separation and enrichment of the organic matters in the natural water body.

### BRIEF DESCRIPTION OF THE DRAWING

FIG. 1 is a flow diagram of a method for separating an organic matter from a natural water body according to the present invention.

### DETAILED DESCRIPTION

The present invention provides a method for separating an organic matter from a natural water body, including the following steps:

filter the natural water body, then adjust pH to 7, allow the natural water body to flow through a first XAD-7HP resin column, and elute the resin column with methanol, where the water sample flowing through the resin column is a first water sample;

adjust the pH of the first water sample to 10, allow the first water sample to flow through a second XAD-7HP resin column, and elute the resin column with hydrochloric acid, where the water sample flowing through the resin column is a second water sample;

adjust the pH of the second water sample to 2, allow the second water sample to flow through a third XAD-7HP resin column, and elute the resin column with a first sodium hydroxide solution, where the water sample flowing through the resin column is a third water sample;

adjust the pH of the third water sample to 7, allow the third water sample to flow through a 15-WET resin column, and elute the resin column with a second sodium hydroxide solution, where the water sample flowing through the resin column is a fourth water sample; and

allow the fourth water sample to flow through an A-23 resin column, and elute the resin column with a third sodium hydroxide solution, where the water sample flowing through the resin column is a fifth water sample.

The present invention filters the natural water body, then adjusts pH to 7, allows the natural water body to flow through a first XAD-7HP resin column, and elutes the resin column with methanol, where the water sample flowing through the resin column is a first water sample. In the present invention, a filter membrane used for the filtering preferably has a pore size of 0.45 μm.

In the present invention, the filter membrane is preferably immersed and cleaned with 1 L of ultrapure water before use. The present invention has no special limit on the time and temperature of the immersion and cleaning, and a manner well known to those skilled in the art may be used.

In the present invention, the natural water body preferably includes surface source water and groundwater of drinking water, a water body after flowing through various treatment units of a water purification plant, and a water body including a dissolved organic matter and flowing into and out of a sewage plant. The present invention has no special limit on the content of the organic matter in the natural water body. In the present invention, the groundwater preferably has a total organic carbon concentration of 0.1-2 mg/L, the surface source water preferably has a total organic carbon concentration of 1-20 mg/L, and the water body flowing through the treatment units of the water purification plant and the water body including a dissolved organic matter and entering or leaving the sewage plant preferably have a total organic carbon concentration of 50-1,000 mg/L.

In the present invention, a buffer solution used for adjusting the pH to 7 is preferably a phosphate buffer solution having a pH of 7. In the present invention, the phosphate buffer solution is preferably prepared by dissolving 68.1 g of potassium dihydrogen phosphate and 11.7 g of sodium hydroxide in 1 L of water to obtain the desired phosphate buffer solution; the phosphate buffer solution may also be prepared by a conventional method well known to those skilled in the art.

The present invention has no special limit on the source of the first XAD-7HP resin column, and a commercially available product well known to those skilled in the art may be used, specifically, an Amberlite XAD-7HP resin column. In the present invention, the first XAD-7HP resin column can adsorb a hydrophobic neutral (HPON) under a neutral condition. In the present invention, the HPON adsorbed on the first XAD-7HP resin column can be eluted with methanol. In the present invention, new or used resins in all the steps are preferably subjected to Soxhlet extraction with methanol for 24 h, and repeatedly washed in sequence with a sodium hydroxide solution, hydrochloric acid and ultrapure water until the pH of an effluent of the resins is 7 and total organic carbon (TOC) is less than 1 mg/L.

The present invention has no special limit on the flow rate of the eluting, and a manner well known to those skilled in the art may be used. Specifically, for a macroporous adsorption resin and a strong-acid cation resin, the elution rate is preferably not higher than 30 column volumes per hour at a time. The column volume is the volume of the resin in the resin column. In the present invention, the ratio of the volume of the natural water body to the volume of the resin is preferably 50:1, and the elution rate of a weak-base anion resin is preferably not higher than 15 column volumes per hour.

After obtaining the first water sample, the present invention adjusts the pH of the first water sample to 10, allows the first water sample to flow through a second XAD-7HP resin column, and elutes the resin column with hydrochloric acid, where the water sample flowing through the resin column is a second water sample.

In the present invention, an adjusting reagent used for adjusting the pH to 10 is preferably a 2 mol/L NaOH solution.

In the present invention, the second XAD-7HP resin column is preferably eluted with 0.25 times column volume of 0.1 mol/L HCl and 1.5 times column volume of 0.01 mol/L HCl in sequence to obtain a hydrochloric acid eluate. The present invention has no special limit on the source of the second XAD-7HP resin column, and a commercially available product well known to those skilled in the art may be used, specifically, an Amberlite XAD-7HP resin column. In the present invention, the second XAD-7HP resin column can adsorb a hydrophobic base (HPOB) under a basic condition. In the present invention, the HPOB adsorbed on the second XAD-7HP resin column can be eluted with hydrochloric acid.

The present invention has no special limit on the flow rate of the elution, and a manner well known to those skilled in the art may be used. For example, for elution with 12.5 mL of 0.1 mol/L HCl and 75 mL of 0.01 mol/L HCl, the flow rate is preferably not higher than 30 column volumes per hour.

After obtaining the second water sample, the present invention adjusts the pH of the second water sample to 2, allows the second water sample to flow through a third XAD-7HP resin column, and elutes the resin column with a first sodium hydroxide solution, where the water sample flowing through the resin column is a third water sample.

In the present invention, an adjusting reagent used for adjusting the pH to 2 is preferably a 1 mol/L HCl solution.

In the present invention, the third XAD-7HP resin column is preferably eluted with 0.25 times column volume of 0.1 mol/L NaOH solution and 1.25 times column volume of 0.01 mol/L NaOH solution in sequence to obtain a first NaOH eluate. The present invention has no special limit on the source of the third XAD-7HP resin column, and a commercially available product well known to those skilled in the art may be used, specifically, an Amberlite XAD-7HP resin column. In the present invention, the third XAD-7HP resin column can adsorb a hydrophobic acid (HPOA) under an acidic condition. In the present invention, the HPOA adsorbed on the third XAD-7HP resin column can be eluted with a first sodium hydroxide solution. In the present invention, the first, second and third XAD-7HP resin columns can preferably be a same resin column, and the specific process is that the water samples repeatedly flow through the resin column for three times.

The present invention has no special limit on the flow rate of the elution, and a manner well known to those skilled in the art may be used. For example, for elution with 12.5 mL of 0.1 mol/L NaOH solution and 62.5 mL of 0.01 mol/L NaOH solution, the flow rate is preferably not higher than 30 column volumes per hour.

After obtaining the third water sample, the present invention adjusts the pH of the third water sample to 7, allows the third water sample to flow through a 15-WET resin column, and elutes the resin column with a second sodium hydroxide solution, where the water sample flowing through the resin column is a fourth water sample.

In the present invention, a buffer solution used for adjusting the pH to 7 is preferably a phosphate buffer solution having a pH of 7 or a 2 mol/L NaOH solution. In the present invention, the phosphate buffer solution is preferably prepared by dissolving 68.1 g of potassium dihydrogen phosphate and 11.7 g of sodium hydroxide in 1 L of water to obtain the desired phosphate buffer solution; the phosphate buffer solution may also be prepared by a conventional method well known to those skilled in the art.

In the present invention, the 15-WET resin column is preferably eluted with 1.5 times column volume of 1 mol/L NaOH solution to obtain a second NaOH eluate. The present invention has no special limit on the source of the 15-WET resin column, and a commercially available product well known to those skilled in the art may be used. In the present invention, the 15-WET resin column is can absorb a hydrophilic base (HPIB). In the present invention, the HPIB adsorbed on the 15-WET resin column can be eluted with a second sodium hydroxide solution.

The present invention has no special limit on the flow rate of the elution, and a manner well known to those skilled in the art may be used. For example, for elution with 50 mL of 1 mol/L NaOH solution, the flow rate is preferably not higher than 30 column volumes per hour.

After obtaining the fourth water sample, the present invention allows the fourth water sample to flow through an A-23 resin column, and elutes the resin column with a third sodium hydroxide solution, where the water sample flowing through the resin column is a fifth water sample.

In the present invention, the A-23 resin column is preferably eluted with 1.5 times column volume of 0.1 mol/L NaOH solution and 1 time column volume of 0.01 mol/L NaOH solution in sequence to obtain a third NaOH eluate. The present invention has no special limit on the source of the A-23 resin column, and a commercially available product well known to those skilled in the art may be used. In the present invention, the A-23 resin column can absorb a hydrophilic acid (HPIA). In the present invention, the HPIA adsorbed on the A-23 resin column can be eluted with a third sodium hydroxide solution.

The present invention has no special limit on the flow rate of the elution, and a manner well known to those skilled in the art may be used. For example, for elution with 75 mL of 0.1 mol/L NaOH solution and 50 mL of 0.01 mol/L NaOH solution, the flow rate is preferably not higher than 30 column volumes per hour.

In the present invention, only a hydrophilic neutral (HPIN) is retained in the fifth water sample.

To further describe the present invention, the method for separating an organic matter from a natural water body provided by the present invention is described below in detail with reference to embodiments, but the embodiments may not be interpreted as a limitation to the protection scope of the present invention.

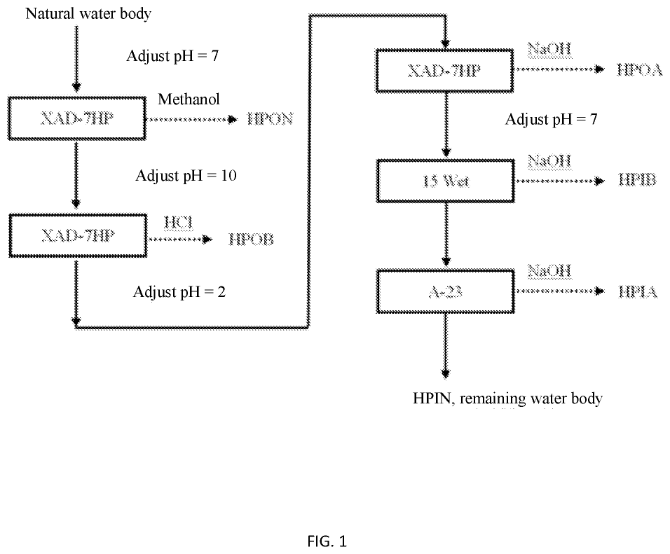

FIG. 1 is a flow diagram of a method for separating an organic matter from a natural water body according to the present invention. The process flow includes: filter the natural water body, then adjust pH to 7, allow the natural water body to flow through a first XAD-7HP resin column, and adsorb a HPON in the natural water body to obtain a methanol eluate; adjust the pH of a water sample that flows through the resin column in the previous step to 10, then allow the water sample to flow through a second XAD-7HP resin column, adsorb a HPOB in the natural water body, and elute with hydraulic acid to obtain a hydraulic acid eluate; adjust the pH of the water sample that flows through the resin column in the previous step to 2, then allow the water sample to flow through a third XAD-7HP resin column, adsorb a HPOA in the natural water body, and elute with a first sodium hydroxide solution to obtain a third water sample; adjust the pH of the third water sample to 7, then allow the third water sample to flow through a 15-WET resin column, adsorb a HPIB in the natural water body, and elute with a second sodium hydroxide solution to obtain a fourth water sample; allow the fourth water sample to flow through an A-23 resin column, adsorb a HPIA in the natural water body, and elute with a third sodium hydroxide solution, retaining a HPIN in the remaining water body.

### Embodiment 1

(1) Take 2.5 L surface water of a drinking water source from a water source area in Jilin Province, filter through a 0.45 μm filter membrane (the filter membrane is immersed and cleaned with 1 L of ultrapure water before filtration), then adjust pH to 7 with a phosphate buffer solution having a pH of 7, allow the water to flow through an XAD-7HP resin column, where at this time, a HPON is retained in the resin column, and elute with 20 mL of methanol, where the flow rate of the methanol elution is not higher than 30 column volumes per hour.

(2) Adjust the pH of the water sample that flows through the column in the previous step to 10 with a 2 mol/L NaOH solution, then allow the water sample to flow through the XAD-7HP resin column again, where at this time, the resin column adsorbs a HPOB, and elute with 0.25 times column volume (12.5 mL) of 0.1 mol/L HCl and 1.5 times column volume (75 mL) of 0.01 mol/L HCl, where the flow rate of the elution is not higher than 30 column volumes per hour.

(3) Adjust the pH of the water sample that flows through the column in the previous step to 2 with 1 mol/L of HCl, then allow the water sample to flow through the XAD-7HP resin column again, where at this time, the resin column adsorbs a HPOA, and elute with 0.25 times column volume (12.5 mL) of 0.1 mol/L NaOH solution and 1.25 times column volume (62.5 mL) of 0.01 mol/L NaOH solution, where the flow rate of the elution is not higher than 30 column volumes per hour.

(4) Adjust the pH of the water sample that flows through the column in the previous step to 7 with a 2 mol/L NaOH solution, then allow the water sample to sequentially flow through a 15-WET resin column and an A-23 resin column, where the 15-WET resin column adsorbs a HPIB, and elute with 1.5 times column volume (75 mL) of 1 mol/L NaOH solution, where the A-23 resin column adsorbs a HPIA, and elute with 1.5 times column volume (75 mL) of 0.1 mol/L NaOH solution and 1 time column volume (50 mL) of 0.01 mol/L NaOH solution.

(5) Finally, retain a component, namely a HPIN that is not adsorbed by any resin in the water sample.

By detection, the source water from a water source area in Jilin Province is classified by this method; the concentration of a dissolved organic matter (DOM) in the source water is 51.48 mg/L before classification, and the concentrations of DOM components sums 52.22 mg/L after classification; the recovery rate is 100.73%.

### Embodiment 2

Embodiment 2 is the same as Embodiment 1, except that the surface water of the drinking water source in Embodiment 1 is replaced with water from a sedimentation tank of a drinking water plant in Jilin Province; the water is classified, and the recovery rate is 110.74%.

The foregoing descriptions are merely preferred implementations of the present invention rather than limitations on the present invention in any form. It should be pointed out that for a person of ordinary skilled in the art, several improvements and modifications may further be made without departing from the principle of the present invention, and the improvements and modifications should also be considered to fall within the protection scope of the present invention.

What is claimed is:

1. A method for separating an organic matter from a natural water body, comprising the following steps:
filtering the natural water body, then adjusting pH to 7, allowing the natural water body to flow through a first XAD-7HP resin column, and eluting the resin column with methanol, wherein the water sample flowing through the resin column is a first water sample;
adjusting the pH of the first water sample to 10, allowing the first water sample to flow through a second XAD-7HP resin column, and eluting the resin column with hydrochloric acid, wherein the water sample flowing through the resin column is a second water sample;
adjusting the pH of the second water sample to 2, allowing the second water sample to flow through a third XAD-7HP resin column, and eluting the resin column with a first sodium hydroxide solution, wherein the water sample flowing through the resin column is a third water sample;
adjusting the pH of the third water sample to 7, allowing the third water sample to flow through a 15-WET resin column, and eluting the resin column with a second sodium hydroxide solution, wherein the water sample flowing through the resin column is a fourth water sample; and
allowing the fourth water sample to flow through an A-23 resin column, and eluting the resin column with a third sodium hydroxide solution, wherein the water sample flowing through the resin column is a fifth water sample.

2. The separation method according to claim 1, wherein a filter membrane used for the filtering has a pore size of 0.45 μm.

3. The separation method according to claim 1, wherein a buffer solution used for adjusting the pH to 7 after the natural water body is filtered is a phosphate buffer solution having a pH of 7.

4. The separation method according to claim 1, wherein an adjusting reagent used for adjusting the pH to 10 is a 2 mol/L NaOH solution.

5. The separation method according to claim 1, wherein the second XAD-7HP resin column is eluted with 0.25 times column volume of 0.1 mol/L HCl and 1.5 times column volume of 0.01 mol/L HCl in sequence to obtain a hydrochloric acid eluate.

6. The separation method according to claim 1, wherein an adjusting reagent used for adjusting the pH to 2 is a 1 mol/L HCl solution.

7. The separation method according to claim 1, wherein the third XAD-7HP resin column is eluted with 0.25 times column volume of 0.1 mol/L NaOH solution and 1.25 times column volume of 0.01 mol/L NaOH solution in sequence to obtain a first NaOH eluate.

8. The separation method according to claim 1, wherein the 15-WET resin column is eluted with 1.5 times column volume of 1 mol/L NaOH solution to obtain a second NaOH eluate.

9. The separation method according to claim 1, wherein the A-23 resin column is eluted with 1.5 times column volume of 0.1 mol/L NaOH solution and 1 time column volume of 0.01 mol/L NaOH solution in sequence to obtain a third NaOH eluate.

10. The separation method according to claim 1, wherein the natural water body comprises surface source water and groundwater of drinking water, a water body after flowing through various treatment units of a water purification plant, and a water body comprising a dissolved organic matter and flowing into and out of a sewage plant.
